(19) United States
(12) Patent Application Publication
(10) Pub. No.: US 2007/0014349 A1
(43) Pub. Date: Jan. 18, 2007

(54) Residual prediction mode in scalable video coding

(75) Inventors: Yiliang Bao, Irving, TX (US); Xianglin Wang, Irving, TX (US); Justin Ridge, Irving, TX (US); Marta Karczewicz, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/446,018

(22) Filed: Jun. 2, 2006

Related U.S. Application Data
(60) Provisional application No. 60/687,058, filed on Jun. 3, 2005.

(51) Int. Cl. H04B 1/66; H04N 11/04; H04N 11/02

(52) U.S. Cl. 375/240.1; 375/240.24; 375/240.25; 375/240.27

(57) ABSTRACT

Methods, devices, and computer code products for encoding and decoding a video signal including conditional encoding and decoding of a residual prediction flag for an enhancement layer only of all base layers are discrete layers. If some base layers are not discrete, the residual prediction flag is always encoded and decoded. Encoding and decoding the residual prediction flag can include using contexts which depend on whether the reconstructed prediction residual of the discrete base layers is zero or not.

### FIELD OF THE INVENTION

The present invention relates generally to the field of video coding and encoding. More specifically, the present invention relates to scalable video coding and decoding systems.

### BACKGROUND INFORMATION

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

In general, conventional video coding standards (e.g., MPEG-1, H.261/263/264) incorporate intra-frame or inter-frame predictions which can be used to remove redundancies within a frame or among the video frames in multimedia applications and services.

In a typical single-layer video codec, like H.264, a video frame is processed in macroblocks. If a macroblock (MB) is an inter-MB, the pixels in the MB can be predicted from the pixels in one or more reference frames. If a macroblock is an intra-MB, the pixels in the MB in the current frame can be predicted entirely from the pixels in the same video frame.

For both inter-MB and intra-MB, the MB can be decoded in the following steps:
Decode the syntax elements of the MB. Syntax elements can include prediction modes and associated parameters;
Based on syntax elements, retrieve the pixel predictors for each partition of MB. An MB can have multiple partitions, and each partition can have its own mode information;
Perform entropy decoding to obtain the quantized coefficients;
Perform inverse transform on the quantized coefficients to reconstruct the prediction residual; and
Add pixel predictors to the reconstructed prediction residuals to obtain the reconstructed pixel values of the MB.

At the encoder side, the prediction residuals can be the difference between the original pixels and their predictors. The residuals can be transformed and the transform coefficients can be quantized. The quantized coefficients can then be encoded using certain entropy-coding schemes.

If a MB is an inter-MB, following information related to mode decision can be coded. Using H.264 as an example, following information can include.
MB type to indicate whether this is an inter-MB;
Specific inter-frame prediction modes that are used. The prediction modes indicate how the MB is partitioned. For example, the MB can have one partition of size 16×16, or two 16×8 partitions and each partition can have different motion information, and so on;
One or more reference frame indices to indicate the reference frames from which the pixel predictors are obtained. Different parts of an MB can have predictors from different reference frames;
One or more motion vectors to indicate the locations on the reference frames where the predictors are fetched.

If the MB is an intra-MB, it can be necessary in some cases to code the following information. Again using H.264 as an example, the following information can include.
MB type to indicate that this is an intra-MB;
Intra-frame prediction modes used for luma. If the luma signal is predicted using the intra4×4 mode, then each 4×4 block in the 16×16 luma block can have its own prediction mode, and sixteen intra4×4 modes can be coded for an MB. If luma signal is predicted using the intra16×16 mode, then one intra16×16 mode can be associated with the entire MB;
Intra-frame prediction mode used for chroma.

In either case, there can be a significant amount of bits spent on coding the modes and associated parameters and texture information that is the prediction residual.

Scalable video coding is a desirable feature for many multimedia applications and services used in systems with a wide range of capabilities. The systems could have different transmission bandwidths, employ decoders with a wide range of processing power, or have displays of different resolutions. Several types of video scalability schemes have been proposed, such as temporal, spatial and SNR scalability in order to achieve the optimal representation on different systems.

In some scenarios, it is desirable to transmit an encoded digital video sequence at some minimum or “base” quality, and in concert transmit an “enhancement” signal that may be combined with the minimum quality signal in order to yield a higher-quality decoded video sequence. Such an arrangement simultaneously allows some decoding of the video sequence by devices supporting some set of minimum capabilities (at the “base” quality), while enabling other devices with expanded capability to decode higher-quality versions of the same sequence, without incurring the increased cost associated with transmitting two independently coded versions of the same sequence.

In some situations, more than two levels of quality may be desired. To achieve that, multiple “enhancement” signals can be transmitted, each building on the “base” quality signal plus all lower-quality “enhancement” signals. Such “base” and “enhancement” signals are referred to as “layers” in the field of scalable video coding. One type of enhancement layer itself can be separated into small units and each small unit can provide incremental quality improvement of fine granularity. This is usually referred to as a Fine granularity scalability (FGS) layer. A scalable video codec, such as JSVM1.0 which is the reference software for the scalable video coding standardization by Joint Video Team between MPEG and ITU/VCEG (“Joint Scalable Video Model 1.0 (JSVM1.0), JVT-N024, January 2005, Hong Kong, China”), may generate multiple FGS quality levels on top of certain base layers in multiple coding passes. In some implementations, all these FGS quality levels are considered as belonging to one FGS layer. For example, under certain configuration, JSVM1.0 could generate one QCIF base layer, and 2 QCIF FGS quality levels, and one CIF enhancement layer for a video frame. In this case, 2 QCIF FGS quality levels belong to the same FGS layer.

In order to achieve good coding efficiency, inter-layer prediction modes can be used for reducing the redundancy among the layers. In each inter-layer prediction mode, the information that has already been coded in the base layer can be used in improving the coding efficiency of the enhancement layer. Inter-layer prediction modes can be used in predicting the mode and motion information in the enhancement layer from that in the base layer or in predicting the texture in the enhancement layer from that in the base layer. Residual prediction is one inter-layer texture prediction mode in which the reconstructed prediction residual of the base layer can be used in reducing the amount of prediction residual to be coded in the enhancement layer. So generally, using a scalable video codec, each video frame can be coded in one or more layers. Two types of scalable layers can be of interest, discrete layers and layers that can be partially decoded. A discrete layer usually is not partially decoded, otherwise the reconstructed video will have major artifacts and the decodability of enhancement layers above this layer can be affected. A partially decodable layer is a layer that even if it is partially decoded, the reconstructed video can still have reasonable quality and the enhancement layers above this layer can still be decoded with certain graceful degradation. In JSVM1.0, the first layer, the spatial enhancement layer and the coarse granularity SNR enhancement layer are examples of the discrete layer. Also in that scalable codec, an FGS (Fine Granularity Scalability) layer can be a partially decodable layer based on the definition given above. In the following discussion, the FGS layer will be used interchangeably with partially decodable layer. However, it should be noted that the partially decodable layer could also have scalability of relatively large granularity.

For residual prediction mode, a residual prediction flag can be coded for a macroblock to indicate whether residual prediction has been used for this macroblock. In some cases conditional coding of the residual prediction flag can be used to reduce the amount of bits spent on coding the residual prediction flags. If the base layer reconstructed prediction residual is zero, residual prediction normally does not help. In this case, the value of the flag can be set to 0 and not coded at all. However, if the base layer residual information available to the decoder is not the same as that available to the encoder, the conditional coding of residual prediction flag may not work properly. As such, there is a need for an improved scheme for coding a residual prediction flag in a scalable video coding system.

### SUMMARY OF THE INVENTION

One embodiment of the invention relates to an improved scheme for coding the residual prediction flag. In one embodiment, conditional coding of the residual prediction flag can be used only if all the base layers are discrete layers. If some base layers are discrete layers and some base layers are FGS layers, the residual predication flag is coded. The residual prediction flag can be coded under contexts which depend upon whether the reconstructed prediction residual of the discrete base layers is zero or not, as well as possibly other information such as the value of residual prediction flags of neighboring macroblocks and/or differences between motion vectors in the current MB and the base layer MB. In an alternative embodiment, the residual prediction flag is always coded, however it is coded in certain contexts as described herein.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

FIG. 1 is a perspective view of a communication device that can be used in an exemplary embodiment.

FIG. 2 is a block diagram illustrating an exemplary functional embodiment of the communication device of FIG. 1.

FIG. 3 is a block diagram illustrating one example of residual prediction in a 2-layer scalable video coding structure.

FIG. 4 is a block diagram illustrating one example of residual prediction involving both an FGS base layer and a discrete base layer.

FIG. 5 is a flow diagram illustrating one embodiment of a method for residual prediction according to the present invention.

FIG. 6 is an illustration of one method for scalable video decoding in accordance with the present invention.

### DETAILED DESCRIPTION OF THE PREFERRED EMBODIMENTS

Exemplary embodiments present methods, computer code products, and devices for efficient enhancement layer encoding and decoding. Embodiments can be used to solve some of the problems inherent to existing solutions. For example, these embodiments can be used to improve the overall coding efficiency of a scalable coding scheme.

As used herein, the term “enhancement layer” refers to a layer that is coded differentially compared to some lower quality reconstruction. The purpose of the enhancement layer is that, when added to the lower quality reconstruction, signal quality should improve, or be “enhanced.” Further, the term “base layer” applies to both a non-scalable base layer encoded using an existing video coding algorithm, and to a reconstructed enhancement layer relative to which a subsequent enhancement layer is coded.

As noted above, embodiments include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions. Any common programming language, such as C or C++, or assembly language, can be used to implement the invention.

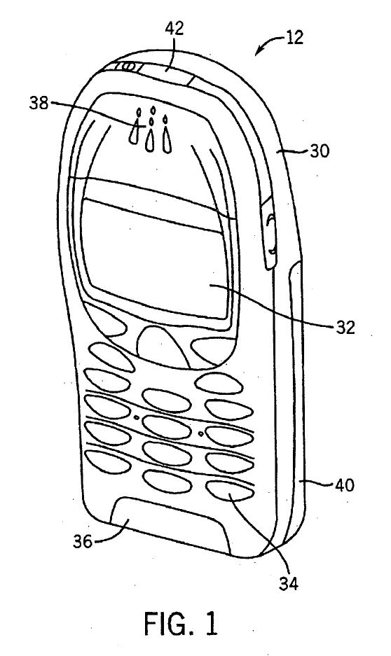

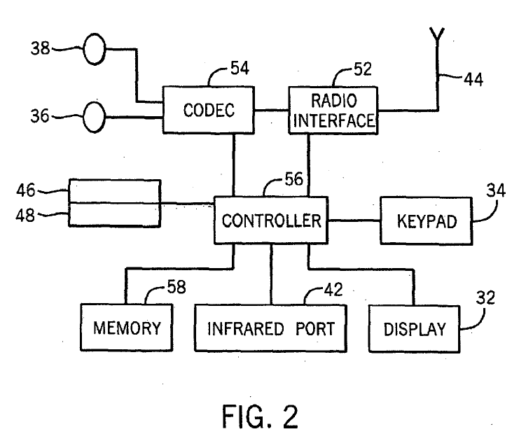

FIGS. 1 and 2 show an example implementation as part of a communication device (such as a mobile communication device like a cellular telephone, or a network device like a base station, router, repeater, etc.). However, it is important to note that the present invention is not limited to any type of electronic device and could be incorporated into devices such as personal digital assistants, personal computers, mobile telephones, and other devices. It should be understood that the present invention could be incorporated on a wide variety of devices.

The device 12 of FIGS. 1 and 2 includes a housing 30, a display 32, a keypad 34, a microphone 36, an ear-piece 38, a battery 40, radio interface circuitry 52, codec circuitry 54, a controller 56 and a memory 58. Individual circuits and elements are all of a type well known in the art, for example in the Nokia range of mobile telephones. The exact architecture of device 12 is not important. Different and additional components of device 12 may be incorporated into the device 12. The scalable video encoding and decoding techniques of the present invention could be performed in the codec circuitry 54, controller 56, and memory 58 of the device 12.

The exemplary embodiments are described in the general context of method steps or operations, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps. Software and web implementations could be accomplished with standard programming techniques, with rule based logic, and/or other logic to accomplish the various database searching steps, correlation steps, comparison steps and decision steps. It should also be noted that the words “module” as used herein and in the claims is intended to encompass implementations using one or more lines of software code, and/or hardware implementations, and/or equipment for receiving manual inputs.

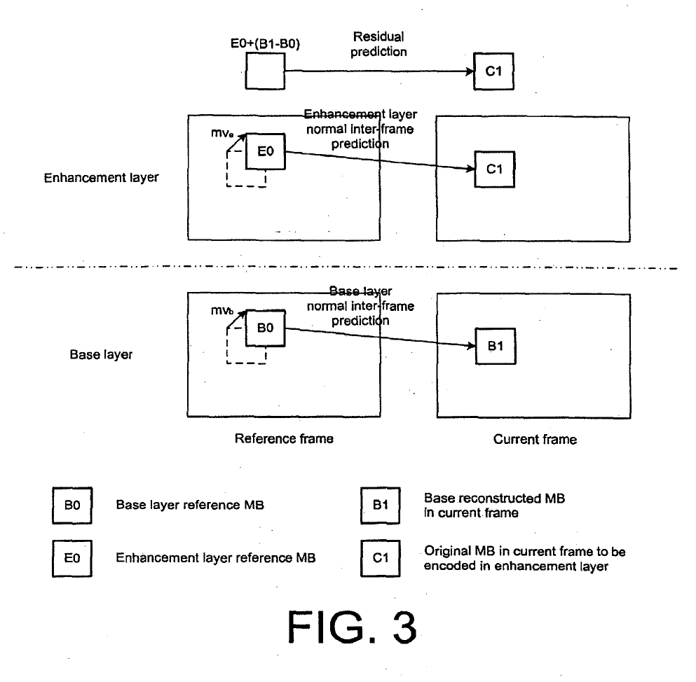

Turning now to residual prediction flag coding, the reconstructed prediction residual of a base layer can be used to reduce the amount of residual to be coded in an enhancement layer. FIG. 3 illustrates one example of residual prediction. In FIG. 3, the reconstructed prediction residual in a base layer for a block is presented as (B1-B0) and the best reference block in the enhancement layer is presented as E0. If the residual prediction mode is not used, the prediction residual to be encoded in the enhancement layer is C1-E0. If residual prediction mode is used, the reconstructed prediction residual in the base layer, (B1-B0), is subtracted from the enhancement prediction residual, (C1-E0). So the actual value to be encoded in the enhancement layer becomes
(C1-E0)−(B1-B0)=C1−(E0+(B1-B0))

Such a coding mode does not always help, i.e., encoding “(C1-E0)−(B1-B0)” is not always more efficient than encoding “(C1-E0)”. A flag, commonly called the residual prediction flag, can be used to indicate whether such a mode is used in encoding the prediction residual of the current MB in the enhancement layer. For example, a flag of value 0 can indicate that residual prediction mode is not used in coding the current MB, and a flag of value 1 can indicate that residual prediction mode is used. If the base layer reconstructed prediction residual is zero, residual prediction may not help. In this case, the value of the flag can be set to 0 and does not need to be coded at all. This is called conditional coding of the residual prediction flag.

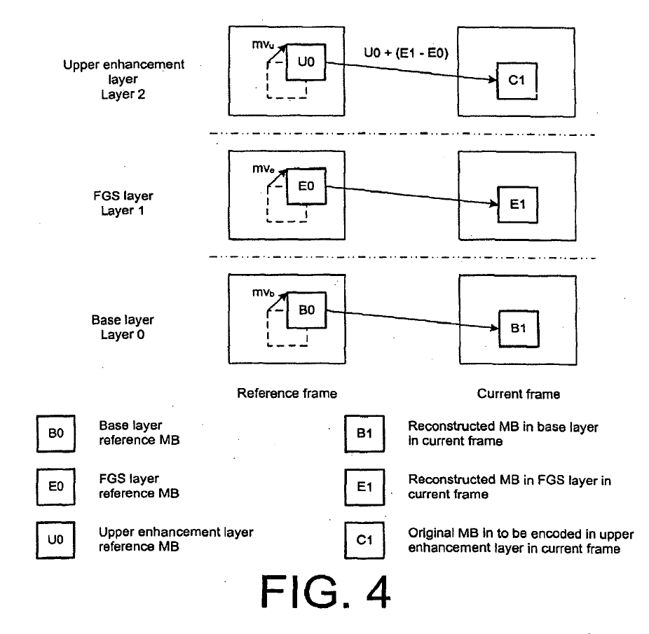

FIG. 4 illustrates one possible 3-layer coding structure where layer 1 is an FGS layer and the base layer (layer 0) is a discrete layer. For an MB in the upper enhancement layer (layer 2), assume the reconstructed prediction residual of the corresponding MB in the FGS layer is nonzero if the FGS layer is fully decoded and the reconstructed prediction residual of the corresponding MB in the base layer is zero. If the encoder performs conditional coding of the residual prediction flag in the upper enhancement layer based on the reconstructed prediction residual of the full FGS layer and that of the base layer, a residual prediction flag should be coded in the encoder. However, if the FGS layer is only partially decoded at the decoder, and the reconstructed prediction residual of the corresponding MB in the FGS layer at this decoding point is still zero, the decoder would not try to decode the residual prediction flag at all. On the other hand, if the encoder performs the conditional coding of the residual prediction flag in the upper enhancement layer based on the reconstructed prediction residual of the base layer (layer 0) only, the encoder will not send the residual prediction flag. But at the decoder side, the decoder will try to decode the residual prediction flag in the upper enhancement layer if the reconstructed prediction residual of the corresponding MB in the FGS layer is nonzero. So there may be a mismatch between the encoder and decoder in either case.

According to one embodiment of the present invention, the residual prediction flag is conditionally coded only if all the base layers are discrete layers. In this case, if the base-layer reconstructed prediction residual that can be used for residual prediction of the current enhancement layer is zero, the value of the residual prediction flag can be inferred to be 0 and the flag does not need to be coded. If some of the base layers are FGS layers, the residual prediction flag is coded with certain contexts. With context-based coding, the residual flags with one context can be coded separately from the residual flags with another context. A set of symbols being coded can be classified according to the contexts, which can be calculated from the information that is already coded, into sub-sets with different probability distributions to improve the overall coding efficiency. The coding contexts for coding the residual prediction flag can depend on the value of the discrete base-layer reconstructed prediction residual calculated from a function of the reconstructed prediction residuals of the discrete base layers. As one particular example, the coding contexts for coding the residual prediction flag can depend whether the discrete base-layer reconstructed prediction residual calculated from a function of the reconstructed prediction residuals of the discrete base layers is zero or not. Alternatively, other information such as the value of the residual prediction flags of neighboring MBs, and the differences between motion vectors of the current MB and motion vectors of the base layer MB can be used in conjunction with the value of the reconstructed prediction flag to determine the residual prediction flag coding context. The discrete base layer normally should be fully reconstructed so the decoder can properly decode the residual prediction flag. There are different ways of calculating the base-layer reconstructed prediction residual to be used for residual prediction of the current enhancement layer from the reconstructed residuals of multiple base layers. One example of such a function is to set the base-layer reconstructed prediction residual to be used for residual prediction of the current layer, say layer n, equal to the reconstructed prediction residual of the immediate base layer, layer (n−1), if the residual prediction mode is not used in the coding of the corresponding MB in layer (n−1), otherwise, if the residual prediction mode is used in the coding of the corresponding MB in layer (n−1), the base-layer reconstructed prediction residual from the lower layers is added to the reconstructed residual of the MB in layer (n−1). Another example of such a function is to always set the base-layer reconstructed prediction residual to the reconstructed prediction residual of the immediate base layer, layer n−1, no matter whether the residual prediction mode is used in coding the corresponding MB in the layer n−1.

In another embodiment of the invention, the residual prediction flag is always coded, regardless of whether or not all of the base layers are discrete layer. In this case, the residual prediction flag can be coded using certain contexts, such as the ones discussed above.

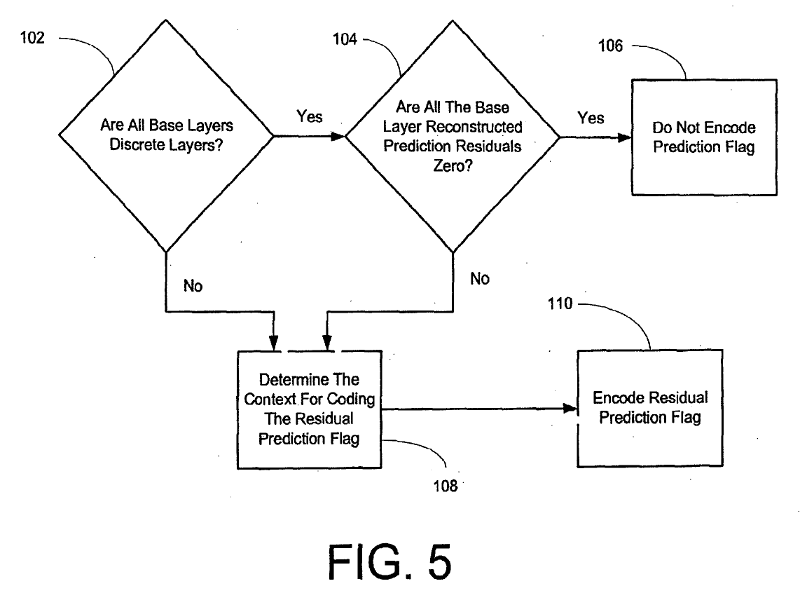

FIG. 5 illustrates one method for scalable video coding. In this embodiment, the device first determines whether all of the base layers are discrete layers 102. If any of the base layers are not discrete layers, the device will encode the residual prediction flag 110. Optionally, the device can determine a context for coding the residual prediction flag 108 based on various information such as whether or not the discrete base-layer reconstructed prediction residual which is calculated from a function of the reconstructed prediction residuals of all discrete base layers is zero, the value of residual prediction flags in neighboring MBs, differences between motions vectors in the current MB and base layer MBs, or any other relevant information.

If all of the base layers are discrete layer, the device determines whether the discrete base-layer reconstructed prediction residual, which can be calculated from a function of the reconstructed prediction residuals of all the discrete base layers, is zero 104. If it is, the residual prediction flag is not coded 106. If the discrete base-layer reconstructed prediction residual, which can be calculated from a function of the reconstructed prediction residuals of all the base layers, is nonzero, the residual prediction flag can be encoded 110. Optionally, the device can determine the context for coding the residual prediction flag 108 as discussed above.

In an alternative embodiment, the residual prediction flag is always coded, however it is coded in certain contexts as described herein.

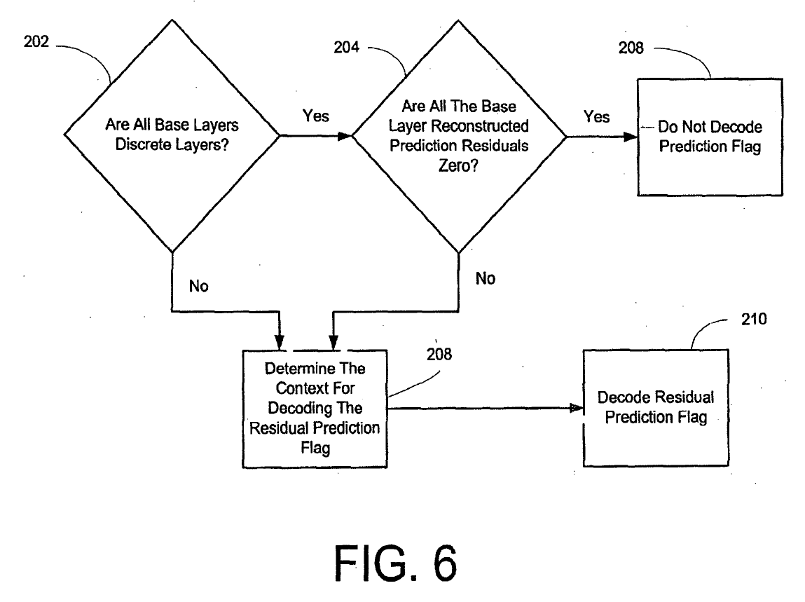

FIG. 6 illustrates one method for scalable video decoding. In this embodiment, the device first determines whether all of the base layers are discrete layers 202. If any of the base layers are not discrete layers, the device will decode the residual prediction flag 210. Optionally, the device can determine a context for decoding the residual prediction flag 208 based on various information such as whether or not the discrete base-layer reconstructed prediction residual, which can be calculated from a function of the reconstructed prediction residuals of all discrete base layers, is zero, the value of residual prediction flags in neighboring MBs, differences between motions vectors in the current MB and base layer MBs, or any other relevant information.

If all of the base layers are discrete layer, the device determines whether the discrete base-layer reconstructed prediction residual, which can be calculated from a function of the reconstructed prediction residuals of all discrete base layers, is zero 204. If it is, the residual prediction flag is not decoded 206. If the discrete base-layer reconstructed prediction residual, which can be calculated from a function of the reconstructed prediction residuals of all discrete base layers, is not zero, the residual prediction flag can be decoded 210. Optionally, the device can determine the context for decoding the residual prediction flag 208 as discussed above.

In an alternative embodiment, the residual prediction flag is always decoded, however it is decoded in certain contexts as described herein.

While several embodiments of the invention have been described, it is to be understood that modifications and changes will occur to those skilled in the art to which the invention pertains. Accordingly, the claims appended to this specification are intended to define the invention precisely.

What is claimed is:

1. An method for decoding a scalable video signal including an enhancement layer and at least one base layer associated with the enhancement layer, each at least one base layer having a reconstructed prediction residual, the method comprising:
determining if all at least one base layers are discrete layers;
if any of the at least one base layers are not discrete layers, always decoding a residual prediction flag for the enhancement layer; and
if all of the at least one base layers are discrete base layers,
calculating a discrete base-layer reconstructed prediction residual from a function of reconstructed residuals of the discrete base layers; and
determining if the discrete base-layer reconstructed prediction residual is non-zero;
if the discrete base-layer reconstructed prediction residual is non-zero, decoding a residual prediction flag for the enhancement layer; and
if the discrete base-layer reconstructed prediction residual is zero, not decoding a residual prediction flag for the enhancement layer.

2. The method of claim 1, wherein decoding a residual prediction flag for the enhancement layer comprises determining a context for decoding the residual prediction flag.

3. The method of claim 2, wherein determining a context depends on whether or not the discrete base-layer reconstructed prediction residual is non-zero.

4. The method of claim 3, wherein the enhancement layer and the at least one base layer each include macroblocks and wherein determining a context further depends on a residual prediction flag for a neighboring macroblock.

5. The method of claim 3, wherein the enhancement layer and at least one base layer each include macroblocks and wherein determining a context further depends on a difference between a motion vector of a macroblock of the enhancement layer and a motion vector of the at least one base layer.

6. An method for encoding a scalable video signal including an enhancement layer and at least one base layer associated with the enhancement layer, each at least one base layer having a reconstructed prediction residual, the method comprising:
determining if all at least one base layers are discrete layers;
if any of the at least one base layers are not discrete layers, always encoding a residual prediction flag for the enhancement layer; and
if all of the at least one base layers are discrete base layers,
calculating a discrete base-layer reconstructed prediction residual from a function of reconstructed residuals of the discrete base layers; and
determining if the discrete base-layer reconstructed prediction residual is non-zero;
if the discrete base-layer reconstructed prediction residual is non-zero, encoding a residual prediction flag for the enhancement layer; and
if the discrete base-layer reconstructed prediction residual is zero, not encoding a residual prediction flag for the enhancement layer.

7. The method of claim 6, wherein encoding a residual prediction flag for the enhancement layer comprises determining a context for encoding the residual prediction flag.

8. The method of claim 7, wherein determining a context depends on whether the discrete base-layer reconstructed prediction residual is non-zero.

9. The method of claim 8, wherein the enhancement layer and the at least one base layer each include macroblocks and wherein determining a context further depends on a residual prediction flag for a neighboring macroblock.

10. The method of claim 8, wherein the enhancement layer and at least one base layer each include macroblocks and wherein determining a context further depends on a difference between a motion vector of a macroblock of the enhancement layer and a motion vector of the at least one base layer.

11. An device for decoding a scalable video signal including an enhancement layer and at least one base layer associated with the enhancement layer, each at least one base layer having a reconstructed prediction residual, the device comprising:
means for determining if all at least one base layers are discrete layers;
if any of the at least one base layers are not discrete layers, means for always decoding a residual prediction flag for the enhancement layer; and
if all of the at least one base layers are discrete base layers,
means for calculating a discrete base-layer reconstructed prediction residual from a function of reconstructed residuals of the discrete base layers; and
means for determining if the discrete base-layer reconstructed prediction residual is non-zero;
if the discrete base-layer reconstructed prediction residual is non-zero, means for decoding a residual prediction flag for the enhancement layer; and
if the discrete base-layer reconstructed prediction residual is zero, means for not decoding a residual prediction flag for the enhancement layer.

12. The device of claim 11, wherein means for decoding a residual prediction flag for the enhancement layer comprises means for determining a context for decoding the residual prediction flag.

13. The device of claim 12, wherein means for determining a context depends on whether the discrete base-layer reconstructed prediction residual is non-zero.

14. The method of claim 13, wherein the enhancement layer and the at least one base layer each include macroblocks and wherein means for determining a context further depends on a residual prediction flag for a neighboring macroblock.

15. The method of claim 13, wherein the enhancement layer and at least one base layer each include macroblocks and wherein means for determining a context further depends on a difference between a motion vector of a macroblock of the enhancement layer and a motion vector of the at least one base layer.

16. An device for encoding a scalable video signal including an enhancement layer and at least one base layer associated with the enhancement layer, each at least one base layer having a reconstructed prediction residual, the device comprising:
means for determining if all at least one base layers are discrete layers;
if any of the at least one base layers are not discrete layers, means for always encoding a residual prediction flag for the enhancement layer; and
if all of the at least one base layers are discrete base layers,
means for calculating a discrete base-layer reconstructed prediction residual from a function of reconstructed residuals of the discrete base layers; and
means for determining if the discrete base-layer reconstructed prediction is non-zero;
if the discrete base-layer reconstructed prediction residual is non-zero, means for encoding a residual prediction flag for the enhancement layer; and
if the discrete base-layer reconstructed prediction residual is zero, means for not encoding a residual prediction flag for the enhancement layer.

17. The device of claim 16, wherein means for encoding a residual prediction flag for the enhancement layer comprises means for determining a context for encoding the residual prediction flag.

18. The device of claim 17, wherein means for determining a context depends on whether the discrete base-layer reconstructed prediction residual is non-zero.

19. The device of claim 18, wherein the enhancement layer and the at least one base layer each include macroblocks and wherein means for determining a context further depends on a residual prediction flag for a neighboring macroblock.

20. The device of claim 18, wherein the enhancement layer and at least one base layer each include macroblocks and wherein means for determining a context further depends on a difference between a motion vector of a macroblock of the enhancement layer and a motion vector of the at least one base layer.

21. A computer program product for decoding a scalable video signal including an enhancement layer and at least one base layer associated with the enhancement layer, each at least one base layer having a reconstructed prediction residual, the computer program product comprising:
computer code configured for:
determining if all at least one base layers are discrete layers;
if any of the at least one base layers are not discrete layers, computer code for always decoding a residual prediction flag for the enhancement layer; and
if all of the at least one base layers are discrete base layers,
computer code for calculating a discrete base-layer reconstructed prediction residual from a function of reconstructed residuals of the discrete base layers; and
computer code for determining if the discrete base-layer reconstructed prediction residual is non-zero;
if the discrete base-layer reconstructed prediction residual is non-zero, computer code for decoding a residual prediction flag for the enhancement layer; and
if the discrete base-layer reconstructed prediction residual is zero, computer code for not decoding a residual prediction flag for the enhancement layer.

22. The computer program product of claim 21, wherein the computer code for decoding a residual prediction flag for the enhancement layer comprises computer code for determining a context for decoding the residual prediction flag.

23. The computer program product of claim 22, wherein the computer code for determining a context depends on whether the discrete base-layer reconstructed prediction residual is non-zero.

24. The computer program product of claim 23, wherein the enhancement layer and the at least one base layer each include macroblocks and wherein the computer code for determining a context further depends on a residual prediction flag for a neighboring macroblock.

25. The computer program product of claim 23, wherein the enhancement layer and at least one base layer each include macroblocks and wherein the computer code for determining a context further depends on a difference between a motion vector of a macroblock of the enhancement layer and a motion vector of the at least one base layer.

26. A computer program product for encoding a scalable video signal including an enhancement layer and at least one base layer associated with the enhancement layer, each at least one base layer having a reconstructed prediction residual, the computer program product comprising:
computer code configured for:
determining if all at least one base layers are discrete layers;
if any of the at least one base layers are not discrete layers, computer code for always encoding a residual prediction flag for the enhancement layer; and
if all of the at least one base layers are discrete base layers,
computer code for calculating a discrete base-layer reconstructed prediction residual from a function of reconstructed residuals of the discrete base layers; and
computer code for determining if the discrete base-layer reconstructed prediction residual is non-zero;
if the discrete base-layer reconstructed prediction residual which is calculated from a function of the reconstructed residuals of all of the at least one discrete base layers is non-zero, computer code for encoding a residual prediction flag for the enhancement layer; and
if the discrete base-layer reconstructed prediction residual which is calculated from a function of the reconstructed residuals of all of the at least one discrete base layers is zero, computer code for not encoding a residual prediction flag for the enhancement layer.

27. The computer program product of claim 26, wherein the computer code for encoding a residual prediction flag for the enhancement layer comprises computer code for determining a context for decoding the residual prediction flag.

28. The computer program product of claim 27, wherein the computer code for determining a context depends on whether the discrete base-layer reconstructed prediction residual is non-zero.

29. The computer program product of claim 28, wherein the enhancement layer and the at least one base layer each include macroblocks and wherein the computer code for determining a context further depends on a residual prediction flag for a neighboring macroblock.

30. The computer program product of claim 29, wherein the enhancement layer and at least one base layer each include macroblocks and wherein the computer code for determining a context further depends on a difference between a motion vector of a macroblock of the enhancement layer and a motion vector of the at least one base layer.

31. A device for decoding a video sequence, the device comprising:
a processor configured to execute instructions;
memory configured for storing a computer program; and
a computer program comprising instructions configured to cause the processor to:
determine if all at least one base layers are discrete layers;
if any of the at least one base layers are not discrete layers, to always decode a residual prediction flag for the enhancement layer; and
if all of the at least one base layers are discrete base layers,
calculate a discrete base-layer reconstructed prediction residual from a function of reconstructed residuals of the discrete base layers; and
determine if the discrete base-layer reconstructed prediction residual is non-zero;
if the discrete base-layer reconstructed prediction residual is non-zero, decode a residual prediction flag for the enhancement layer; and
if the discrete base-layer reconstructed prediction residual is zero, not decode a residual prediction flag for the enhancement layer.

32. The device of claim 31, wherein decoding a residual prediction flag for the enhancement layer comprises determining a context for decoding the residual prediction flag.

33. The device of claim 32, wherein determining a context depends on whether the discrete base-layer reconstructed prediction residual is non-zero.

34. The device of claim 33, wherein the enhancement layer and the at least one base layer each include macroblocks and wherein determining a context further depends on a residual prediction flag for a neighboring macroblock.

35. The device of claim 33, wherein the enhancement layer and at least one base layer each include macroblocks and wherein determining a context further depends on a difference between a motion vector of a macroblock of the enhancement layer and a motion vector of the at least one base layer.

36. A device for encoding a video sequence, the device comprising:
a processor configured to execute instructions;
memory configured for storing a computer program; and
a computer program comprising instructions configured to cause the processor to:
determine if all at least one base layers are discrete layers;
if any of the at least one base layers are not discrete layers, to always encode a residual prediction flag for the enhancement layer; and
if all of the at least one base layers are discrete layers,
calculate a discrete base-layer reconstructed prediction residual from a function of reconstructed residuals of the discrete base layers; and
determine if the discrete base-layer reconstructed prediction residual is non-zero;
if the discrete base-layer reconstructed prediction residual is non-zero, encode a residual prediction flag for the enhancement layer; and
if the discrete base-layer reconstructed prediction residual is zero, not encode a residual prediction flag for the enhancement layer.

37. The device of claim 36, wherein encoding a residual prediction flag for the enhancement layer comprises determining a context for encoding the residual prediction flag.

38. The device of claim 37, wherein determining a context depends on whether the discrete base-layer reconstructed prediction residual is non-zero.

39. The device of claim 38, wherein the enhancement layer and the at least one base layer each include macroblocks and wherein determining a context further depends on a residual prediction flag for a neighboring macroblock.

40. The device of claim 38, wherein the enhancement layer and at least one base layer each include macroblocks and wherein determining a context further depends on a difference between a motion vector of a macroblock of the enhancement layer and a motion vector of the at least one base layer.

41. A method for decoding a scalable video signal including an enhancement layer and at least one discrete base layer associated with the enhancement layer, each enhancement layer and discrete base layer including macroblocks, the method comprising:
determining a prediction residual for a macroblock of the at least one discrete base layer;
determining whether the determined prediction residual is zero;
if the determined prediction residual is zero, using a first context to decode the prediction residual flag;
if the determined prediction residual is not zero, using a second context to decode the prediction residual flag.

42. The method of claim 41 further comprising:
determining if any of the at least one discrete base layers includes a partially decodable layer;
if any of the at least one discrete base layers includes a partially decodable layer, always decoding a residual prediction flag for a macroblock of the enhancement layer;
if none of the at least one discrete base layers includes a partially decodable layer,
calculating a discrete base-layer reconstructed prediction residual from a function of reconstructed residuals of a macroblock of the discrete base layers;
determining if the discrete base layer reconstructed prediction residual is non-zero;
if the discrete base layer reconstructed prediction residual is non-zero, decoding a residual prediction flag for the macroblock of the enhancement layer; and
if the discrete base layer reconstructed prediction residual is zero, not decoding a residual prediction flag for the macroblock of the enhancement layer.

43. The method of claim 41, wherein determining a context further depends on a residual prediction flag for at least one neighboring macroblock of the enhancement layer.

44. The method of claim 41, wherein determining a context further depends on a difference between a motion vector of a macroblock of the enhancement layer and a motion vector of the a macroblock of the at least one discrete base layer.

45. A method for encoding a scalable video signal including an enhancement layer and at least one discrete base layer associated with the enhancement layer, each enhancement layer and discrete base layer including macroblocks, the method comprising:
determining a prediction residual for a macroblock of the at least one discrete base layer;
determining whether the determined prediction residual is zero;
if the determined prediction residual is zero, using a first context to encode the prediction residual flag;
if the determined prediction residual is not zero, using a second context to encode the prediction residual flag.

46. The method of claim 45 further comprising:
determining if any of the at least one discrete base layers includes a partially encodable layer;
if any of the at least one discrete base layers includes a partially encodable layer, always encoding a residual prediction flag for a macroblock of the enhancement layer;
if none of the at least one discrete base layers includes a partially encodable layer,
calculating a discrete base-layer reconstructed prediction residual from a function of reconstructed residuals of a macroblock of the discrete base layers;
determining if the discrete base layer reconstructed prediction residual is zero;
if the discrete base layer reconstructed prediction residual is zero, not encoding a residual prediction flag for the macroblock of the enhancement layer; and
if the discrete base layer reconstructed prediction residual is non-zero, encoding a residual prediction flag for the macroblock of the enhancement layer.

47. The method of claim 45, wherein determining a context further depends on a residual prediction flag for at least one neighboring macroblock of the enhancement layer.

48. The method of claim 45, wherein determining a context further depends on a difference between a motion vector of a macroblock of the enhancement layer and a motion vector of the a macroblock of the at least one discrete base layer.

49. A device for decoding a scalable video signal including an enhancement layer and at least one discrete base layer associated with the enhancement layer, each enhancement layer and discrete base layer including macroblocks, the device comprising:
a controller for determining a prediction residual for a macroblock of the at least one discrete base layer and for determining whether the determined prediction residual is zero;
a decoder for using a first context to decode the prediction residual flag if the determined prediction residual is zero and for using a second context to decode the prediction residual flag if the determined prediction residual is not zero.

50. The device of claim 49 further comprising:
a controller doe determining if any of the at least one discrete base layers includes a partially decodable layer;
a decoder for always decoding a residual prediction flag for a macroblock of the enhancement layer if any of the at least one discrete base layers includes a partially decodable layer;
if none of the at least one discrete base layers includes a partially decodable layer,
the controller is further configured to calculate a discrete base-layer reconstructed prediction residual from a function of reconstructed residuals of a macroblock of the discrete base layers and determine if the discrete base layer reconstructed prediction residual is non-zero;
the decoder is further configured for decode a residual prediction flag for the macroblock of the enhancement layer if the discrete base layer reconstructed prediction residual is non-zero and to not decode a residual prediction flag for the macroblock of the enhancement layer if the discrete base layer reconstructed prediction residual is zero.

51. The device of claim 49, wherein determining a context further depends on a residual prediction flag for at least one neighboring macroblock of the enhancement layer.

52. The device of claim 49, wherein determining a context further depends on a difference between a motion vector of a macroblock of the enhancement layer and a motion vector of the a macroblock of the at least one discrete base layer.
